(19) United States
(12) Patent Application Publication
(10) Pub. No.: US 2014/0340498 A1
(43) Pub. Date: Nov. 20, 2014

(54) USING DISTANCE BETWEEN OBJECTS IN TOUCHLESS GESTURAL INTERFACES

(71) Applicant: Google Inc., Mountain View, CA (US)

(72) Inventors: Christian Plagemann, Palo Alto, CA (US); Alejandro Kauffmann, San Francisco, CA (US); Joshua Kaplan, San Francisco, CA (US)

(73) Assignee: Google Inc., Mountain View, CA (US)

(21) Appl. No.: 13/721,837

(22) Filed: Dec. 20, 2012

(51) Int. Cl. G01B 11/14; H04N 7/18

(52) U.S. Cl. CPC G01B 11/14; H04N 7/18
USPC 348/77

(57) ABSTRACT

A function of a device, such as volume, may be controlled using a combination of gesture recognition and an interpolation scheme. Distance between two objects such as a user's hands may be determined, at a first time point and a second time point. The difference between the distances calculated at two time points may be mapped onto a plot of determined difference versus a value of the function to set the function of a device to the mapped value.

### BACKGROUND

Gesture control of devices typically allows a user to interact with a particular feature of a device. For example, a user may direct a light to activate based on a hand wave gesture. A gesture may be detected by a depth camera or a RGB camera. The camera may monitor an environment for gestures from a user. Video game consoles also use a single camera to provide gesture-based interfaces. For example, a hand-to-hand combat game may detect a punch thrown by a user and have a video game opponent respond to that punch on a TV screen. Virtual reality also provides user with an immersive environment, usually with a head mounted display unit.

### BRIEF SUMMARY

According to an implementation of the disclosed subject matter, a first distance between at least a first object, such as a body pan, and a second object at a first time may be determined. The first object and the second object may not be in physical contact with a device. The device may include a function with a range of selectable values. A second distance between the first object and the second object at a second time may be determined. The difference between the first distance and the second distance may be determined. In some configurations, the determined difference may be mapped based on an interpolation scheme. An interpolation scheme my include a plot of the range of selectable values versus the determined difference. The plot may be non-linear and it may define a predetermined minimum and maximum value in the range. One of the selectable values in the range of selectable values may be selected based on the determine difference.

In an implementation a system is disclosed that includes as database, at least one camera, and as processor. The database may store positions of a first object and a second object. The one or more cameras may capture the position of the first object and the second object. The processor may be connected to the database and configured to determine at a first time a first distance between the first object and the second object. The first object and the second object may not be in physical contact with the device. The device may include a function with two or more selectable values. The processor may be configured to determine at a second time a second distance between the first object and the second object. It may determine the difference between the first distance and the second distance and select one of the selectable values based on the determined difference.

Additional features, advantages, and implementations of the disclosed subject matter may be set forth or apparent from consideration of the following detailed description, drawings, and claims. Moreover, it is to be understood that both the foregoing summary and the following detailed description are exemplary and are intended to provide further explanation, without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed, subject matter.

FIG. 3 shows an example process flow according to an implementation disclosed herein.

FIG. 4A shows an example linear or absolute interpolation scheme while FIG. 4B shows an example non-linear interpolation scheme. Each has a predetermined minimum and maximum value for the function.

FIG. 5A shows a user's hands at an initial distance apart. FIG. 5B shows the user's hands coming together. FIG. 5C shows the distance between the user's hands expanding. For each of FIGS. 5A-5C, a linear or absolute interpolation scheme is employed.

FIG. 6A shows a user's hands at an initial distance apart. FIG. 6B shows the user's hands coming together. FIG. 6C shows the distance between the user's hands expanding. For each of FIGS. 6A-6C, a non-linear or absolute interpolation scheme is employed.

### DETAILED DESCRIPTION

According to an implementation disclosed herein, changes in the distance between two objects, such as a user's hands or portion thereof, may be detected. The determined distance may be utilized to control a function of as device, such as the volume of a speaker. For example, when a user holds up his hands and then moves them apart, the increased distance between the hands may be detected and cause the volume to increase. Conversely, when the hands move closer together, the volume can be decreased. The orientation of the hands can be detected and used to decide which function or device to control. For example, moving the hands apart while holding them in parallel to each other may control volume; doing so with the palms facing the device may control screen brightness.

Detecting and using this type of gesture can be expressed as measuring a first distance between the hands at a first time, and then measuring a second distance between them at a second time. Comparing these two distances over time can indicate whether the hands are moving apart, moving closer together, or staying at about the same distance apart. This can then be used to change the controlled function.

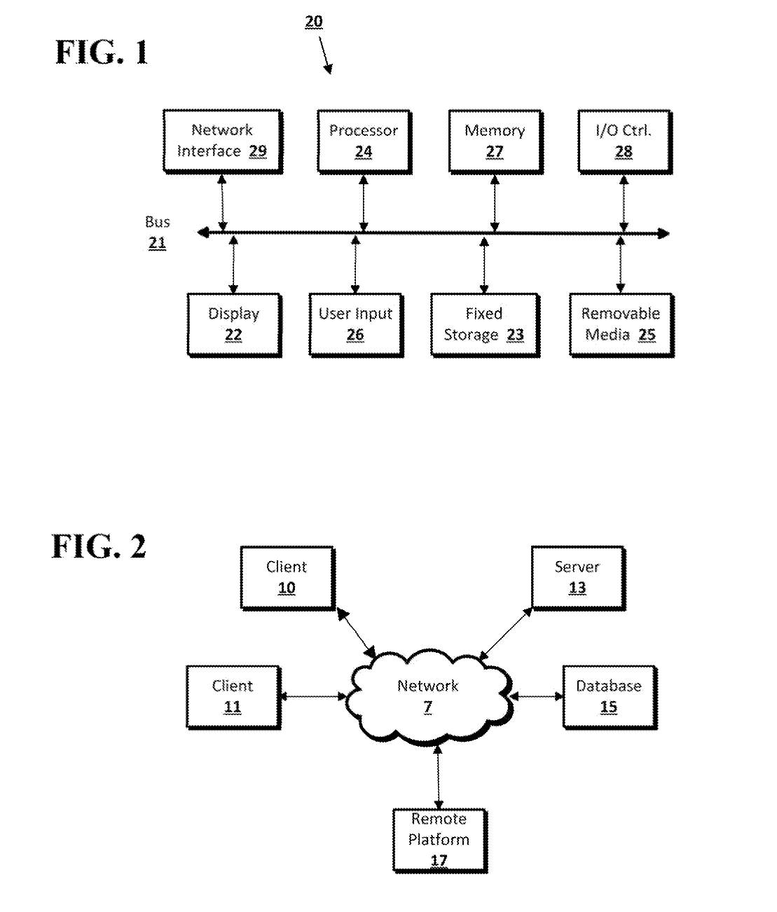

Implementations of the presently disclosed subject matter may be implemented in and used with a variety of component and network architectures. FIG. 1 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (MS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on is remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes, implementations also may be embodied in the form of a computer program product having computer program code containing instructions embodied in non transitory and/or tangible media, such as floppy diskettes, CD-ROMs, hard drives, USB (universal serial bus) drives, or any other machine readable storage medium, wherein, when the computer program code is loaded into and executed by a computer. the computer becomes an apparatus for practicing implementations of the disclosed subject matter. Implementations also may be embodied in the form of computer program code, for example, whether stored in as storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on it computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

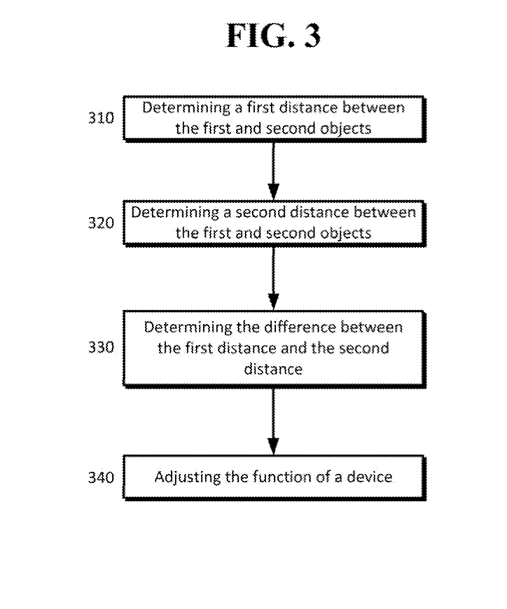

In an implementation, a first distance may be determined at a first time at 310. as shown in FIG. 3. The first distance may refer to the distance between a first object and a second object. An object may be a body part, such as a hand, or a portion of a body part, such as a finger. In addition, orientation of the object, such as whether or not a user's palms are facing the device or not, may be detected and utilized to uniquely identify or select a device, a function, or a gesture. An object may refer to an inanimate object such as a chair. The first object and the second object may be a combination of a body part and an inanimate object. For example, a distance may be calculated between a chair and a user's hand. The first distance may be stored to a computer readable memory or to persistent storage. For example, a camera utilized to capture gestures in an environment may be connected to a computing device that may calculate the distance between two objects for one or more of the disclosed implementations. The first object and the second object may not be in physical contact with one another. For example, a user's hands may be treated as separate objects. Thus, selected portions of an object may be treated as separate so long as the selected portions are not in physical contact with one another.

An object may be detected by a camera. For example, one or more depth cameras may be used to identify as user or a particular part of a user or an inanimate object. In a configuration, a user may indicate an object with which the user would like to interact. For example, a user may view a depth camera's rendering of an environment. The user may identify one or more objects within the environment. The identified object may be used as a component of the distance calculation between, for example, the identified object and a user's hand. Techniques and methods for capturing an environment using a camera and identifying objects within the environment are understood by person having ordinary skill in the art. In the event that an identified object is not detected in the environment, a distance calculation may not be possible. The user may be notified, for example an on-screen notice may appear, that it is not possible to determine the distance because of a missing object or inability to detect the object. If, however, both the first object and the second object are detected, then the first distance between a first object and a second object may be determined. For example, typically a depth camera may determine the location of various objects within the field of view of camera. A depth camera system may be configured to recognize objects in its field of view. The depth camera may be connected to a computing device that may analyze image data received from the camera. A processor may identify objects of the environment of an individual image, representing the single frame of the field of view of the camera, and this may be referred to as preprocessing. Preprocessing may refer to an adjustment of a feature of a single image frame. A feature of the frame may refer to brightness, sharpness, contrast, image smoothing.

An image frame captured by a camera may be time stamped or otherwise chronologically tagged. For example, a series of image frames may be stored in chronological order in a database. The time data may be used to determine a reference time for the first distance calculation. An image frame may be time stamped as time 0 (t₀) once the camera or computing device connected thereto recognizes a gesture or a hand movement that may be gesture. For example, a user may raise her hands to a threshold height relative to her body. The camera may detect the presence of the user's hands above the threshold height and determine that a gesture may be forthcoming. It may begin storing time-stamped image frames. Each frame captured from the camera may be time stamped as t₀, t_{0.5}, t_{1.0}, t_{1.5}, t_{2.0}, . . . tₙ, for example, where the camera captures an image every half second. Any distance determination may, therefore, be time stamped in any implementation disclosed herein.

Similar to the first distance, a second distance may be determined between the first object and the second object at 320 as shown in FIG. 3, For example, a user may hold a hand (first object) up and hold a book up (second object). The first distance may be calculated as the distance between the book and the user's hand when they are first brought up or detected above a threshold height and the first distance may be time stamped as t₀. It may be stored in a database belonging to a computing device such as a server or a desktop PC. The user may then move her hand further away from the hook while holding the book in approximately the same position. The second distance may refer to any distance between the user's hand and the book that does not match that of the t₀ distance (e.g., first distance). For example, if images are captured every half second, the second distance may refer to the image captured at t_{0.5}. The user's movement of her hand away from the book may require more than a half second to complete. The second distance may refer to the resting point of the uses movement of her hand away from the book. That is, a user may momentarily pause upon completing a gesture and maintain the one or more objects in the last position used for the gesture. Implementations disclosed herein are not limited to merely two distances being determined between the two objects. For example, images may be captured at t₀, t_{0.5}, t_{1.0}, t_{1.5}, t_{2.0}, . . . , tₙ₋₁, tₙ and analyzed for distances between two objects. Distances may be calculated for one or more of the time points as the absolute value of the difference between two objects at two different times as follows: first distance, t₀-t_{0.5}; second distance, t_{0.5}-t_{1.0}; third distance, t_{1.0-t}_{1.5}; fourth distance, t_{1.5}t_{2.0}; nth distance, tₙ₋₁-tₙ. Further, an initial distance may refer to, for example, the t₀ time stamped image from the camera or it may refer to a distance that is chronologically before a subsequent distance. For example, t_{1.0} may be an initial distance relative to t_{2.0}.

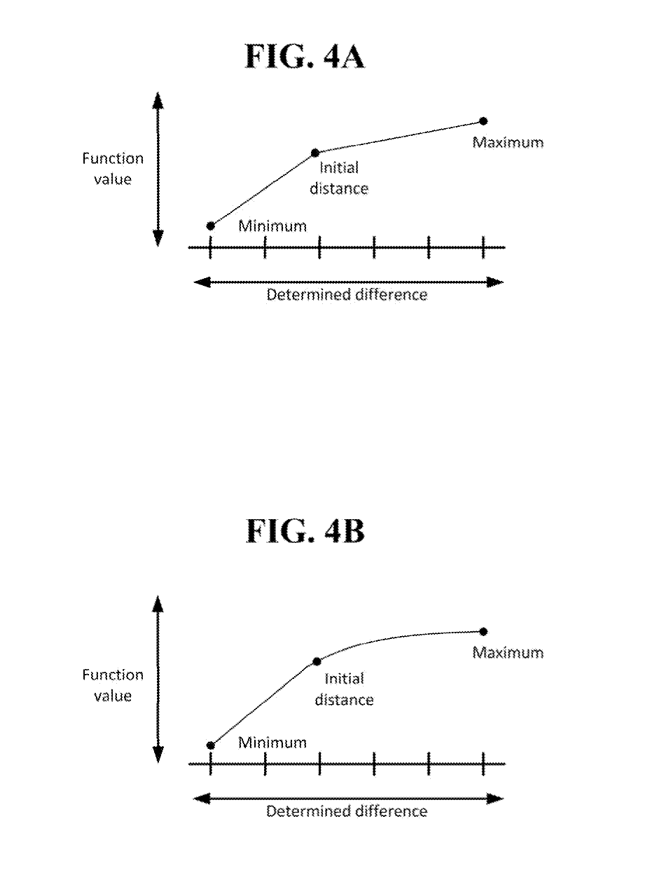

Each distance calculated, such as the first distance and the second distance, may be compared to determine the difference between chronologically adjacent distance values at 330. For example the first distance may be represented by t₀-t_{0.5} and may be subtracted from the second distance, t_{0.5}-t_{1.0}. Similarly, the second distance may be subtracted from the nth distance, tₙ₋₁-tₙ. The determined difference between two calculated differences may be utilized to adjust the function of a device at 340. For example, the volume of a stereo feature may be modified in the manner disclosed. A user may desire to increase the volume setting of a stereo. The user may do so by holding her hands up (sec for example the position of the hands in FIG. 4A). The gesture may be interpreted by the system as the user desiring to adjust the volume of the stereo. The user may also have delivered an event trigger (discussed below) to indicate to the system what device and what feature the user would like to control. To increase the volume, the user may separate her hands, Image frames captured by the camera may detect the user's gestures, particularly the hands separating. The distance between the hands increases as a function of time in this example causing the volume of the stereo to increase. A similar process may be followed to decrease a function of a device. That is, the user may begin with her hands slightly apart and bring them together to, for example, decrease the volume of the stereo. The gesture may also be used to adjust the function to a maximum or minimum value and that maximum or minimum may be predefined by the device or the system.

One of the values for the function may be selected based on the determined difference using a linear scale or other non-linear scales or methods. In the preceding example, the user raises her hands a certain distance apart. Hand distance may be linearly correlated with as selectable value of a function of a device. For example, the user's hands may initially be 20 cm apart and that distance apart may cause the system to adjust the stereo volume to 60 dB. As the user moves her hands to 10 cm apart, the system may increase the volume linearly to 70 dB.

For example, in a system that uses a three dimensional depth camera to track a user's body, when the user raises his/her hands above his waist and holds them at the same height, palms facing each other, then the distance between them may correspond to the brightness of a lamp on a dimmer. Moving the hands apart may increase the brightness of the light while moving them closer together may dim it. The distance between the hands may be mapped absolutely such that hands touching is completely off and hands spread 20 cm apart is completely on. The distance may also be relative to their initial distance from each other when they are first raised above the waist. In the relative case, the initial distance between the hands can be treated as the factor by which all subsequent movements are measured or it can be interpolated, between pre-established maximum and minimum distances so that the entire range of the control may be available regardless of the initial distance between the hands.

To avoid having the function of the device immediately adjust to a value based upon a linear mapping of the initial distance between the two objects to the range of selectable values for the functions and interpolation scheme may be employed. An interpolation scheme may refer to a plot of the selectable values for a function of as device versus the determined distance. For example, FIG. 4A and 4B show examples of an absolute or linear interpolation scheme and a relative interpolation scheme respectively. In some instances, the interpolation scheme may be limited by a minimum and maximum of the selectable values. For example, a stereo may have a minimum and/or maximum volume setting. Adjustment of volume based on the determined difference may be limited to a selectable value that is equal to or between the minimum and maximum. FIG. 4A shows a plot that is formed from two lines with different slopes. One line with a first slope describes points between a minimum value and the value corresponding to the initial distance. A second line with a second slope describes points between the value corresponding to the initial distance and the maximum value. FIG. 4B shows an interpolation scheme that is described by a non-linear curve of the determined distance and a selectable value. Any such curve can be used in this manner, including a step function. The curve need not be continuous. A gap in the curve can be interpreted by the system as segments where the function turns off, where it returns to a default value or tracks a separately provided curve or prescribed behavior.

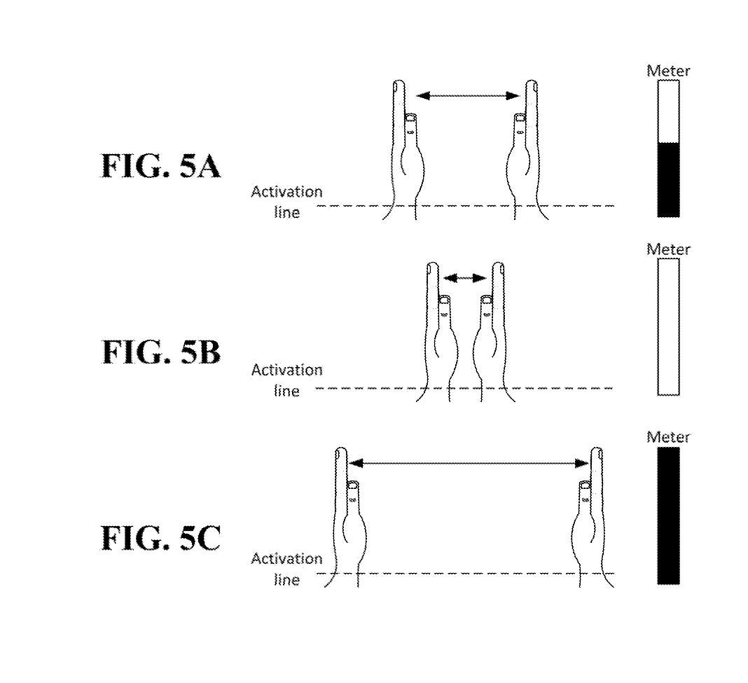

FIG. 5A shows an example of hands at an initial distance apart and above a threshold height. As described earlier, the threshold height may be set at virtually any level, including a predetermined distance relative to a user's body. Other techniques may be used as a trigger event (discussed below). The meter indicates the value of the function that is determined based on the initial distance the hands are apart. In some configurations, the value selected based on the initial distance may be set at the current value of the function. For example, if the brightness of a lamp is at a level 5 on a scale of 0-10, regardless of how far apart a user's hands are when brought above the activation line (e.g., threshold height or activation line), the initial distance may be mapped to a selectable value of 5. If a user brings her hands closer together, as shown in FIG. 5B, the selectable value may decrease linearly to the minimum. Similarly, as the user moves her hands apart, as shown in FIG. 5C, the selectable value may increase linearly to the maximum. The meter shows that, based on the determined difference between the initial distance and the current distance apart, the function has been assigned a value of 10 on a scale of 0-10. As described earlier, the linear interpolation that describes the plot of the determined difference versus the selectable value of the function of a device.

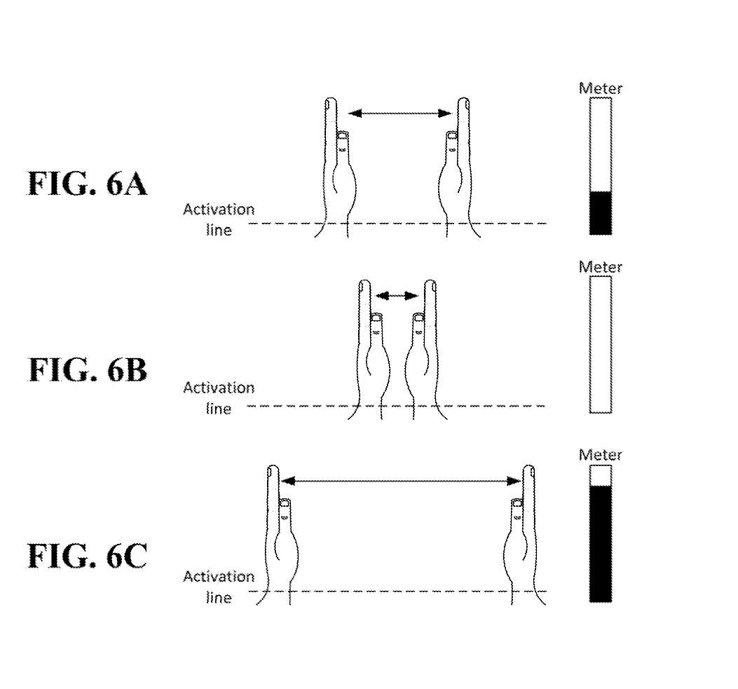

FIG. 6A shows a user's hands above the activation line and an initial distance apart. Unlike the FIG. 5 interpolation scheme, when the user initially holds her hands above the activation line, the distance between the hands is use to map a relative position on a plot of the determined difference versus a value of the function between a defined minimum and maximum. The meter indicates the selected value on a scale of, for example, 0-10. FIG. 6B shows the user bringing her hands close together. The determined difference between the initial distance shown in FIG. 6A and the distance between the hands in FIG. 6B causes the selected value to be the minimum for the function which is 0. In contrast, if the user expands the distance between her hands as shown in FIG. 6C, the selected value may approach a maximum.

In some configurations it may be desirable to have a predefined minimum or maximum for a function where one or both are asymptotically approached. This may be desirable for a function such as volume where it may be desirable to slowly increase the volume as one approaches the maximum, slowly decrease the volume as one approaches the minimum, etc. Moreover, a gesture may be repeated to cause a subsequent or additional analysis according to the implementations disclosed herein. For example, a user may begin with her hands in the position shown in 6A and end with them in the position and distance shown in 6C to indicate that she would like the volume to increase. The user may lower her hands and again raise them. The initial distance of the hands apart may now be mapped to the increased volume and if the user expands the distance between her hands again (c.f., FIG. 6A and 6C), the volume may again increase. The amount that the volume increases may depend on the interpolation scheme used for the function or device.

A trigger event may be used to signal to the camera or computing device connected thereto that a gesture is about to be delivered. The trigger event may also be used to describe a signal as to which device a gesture is directed towards. An example of a trigger event may be if a user holds her hands above a threshold height (e.g., the activation line shown in FIGS. 5A-5C and 6A-6C) relative to the user's body. As described earlier, a threshold height may be a user's shoulders. If the system detects that, for example, one or more of a user's hands are above shoulder height, then it may begin capturing images and attempting to discern a gesture. Another example of an event trigger could be a voice command that, when spoken, signifies to the system that it should prepare to receive a gesture for a particular device. Another example of an event trigger may be an audible sound. A gesture may also be used as an event trigger. For example, a system may continuously monitor an environment for gestures. The system may recognize a particular gesture that instructs it to perform a distance calculation between two identified objects.

As described above, a gesture may be used to control a function of a device. The function may have a range of selectable values. For example, a stereo receiver (e.g., device) allows one to control the volume output (function). The volume may be adjustable on a continuous or discrete scale such as by a dial or preset numerical value. Similarly, brightness of a screen or a lamp may be adjusted according to the implementations disclosed herein. Other examples of a function includes without limitation, a frequency setting, a time setting, a timer setting, a temperature, a color intensity, a light intensity, a zoom setting, a fast forward function, a channel setting, and a rewind function. A function may have a two or more selectable values that may be increased, decreased, maximized, or minimized.

In some configurations, a velocity may be determined based on the determined difference and a time difference between the first distance and the second distance. An acceleration may also be calculated based on the determined velocity. The velocity or acceleration may be a factor in an interpolation scheme. For example, if a user quickly moves her hands apart, it may be used to linearly adjust the volume. A quick motion may also signal that the user would like to approach the minimum or maximum faster by using a more aggressive interpolation scheme.

In some configurations, multiple devices may be controlled according to the implementations disclosed herein. In an implementation, a device may be identified by, for example, a gesture, a voice command, an audible sound, or a remote control selection. A device may also be identified by determining the device the user is facing. For example, a depth camera may determine which device the user is looking at or gesturing toward.

In an implementation, a system is provided that includes a database fur storing positions of a first object and a second object. For example, a computing device may be connected to a depth camera and analyze the camera image data. The system may include at least one camera to capture the position of the first object and the second object. A processor connected to the database and configured to determine at a first time a first distance between the first object and the second object. As described earlier, the first object and the second object are not in physical contact with a device. The device may include one or more functions with at least two selectable values. The processor may be configured to determine at a second time a second distance between the first object and the second object. The difference between the first distance and the second distance may be determined by the processor. One of the values of the function may be selected based on the determined difference.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
determining at a first time a first distance between it first object and a second object, wherein the first object and the second object are not in physical contact with a device, where the device comprises a function with a plurality of selectable values;
determining at a second time a second distance between the first object and the second object;
determining the difference between the first distance and the second distance; and
selecting one of the plurality of selectable values based on the determined difference.

2. The method of claim 1, further comprising mapping the determined difference based on an interpolation scheme.

3. The method of claim 2, wherein an interpolation scheme comprises a plot of the plurality of Selectable values versus the determined distance.

4. The method of claim 2, further comprising determining the one of the plurality of selectable values corresponding to the determined difference,

5. The method of claim 3, wherein the plot is non-linear.

6. The method of claim 3, wherein the plot defines a predetermined minimum and maximum.

7. The method of claim 1, wherein an object comprises a body part.

8. The method of claim 1, wherein the first object comprises at least a portion of a first hand and the second object comprises at least a portion of a second hand.

9. The method of claim 8, wherein the step of determining the first distance comprises determining a position of a user's body.

10. The method of claim 8, further comprising determining that the first portion and second portion are above a threshold height relative to the user's body.

11. The method of claim 8, herein the first portion of the first hand comprises at least a single finger.

12. The method of claim 8, wherein the second portion of the second hand comprises at least a single finger.

13. The method of claim 8, further comprising detecting an orientation of at least a portion of to hand.

14. The method of claim 9, further comprising selecting the function of the device based on the detected orientation.

15. The method of claim 1, further comprising determining a velocity based on the determined difference and a time difference between the first distance and the second distance.

16. The method of claim 15, further comprising determining an acceleration based on the determined velocity.

17. The method of claim 1, further comprising recognizing the first object and the second object above a threshold height.

18. The method of claim 1, wherein the function is selected from the group consisting of: a volume setting, a frequency setting, a time setting, a timer setting, a temperature, a color intensity, a light intensity, a zoom setting, a screen brightness, a fast forward function, a channel setting, and a rewind function.

19. The method of claim 1, further comprising identifying the device to be modified.

20. The method of claim 19, wherein the step of identifying the device comprises determining the device a user is facing.

21. The method of claim 19, wherein the step of identifying the device comprises determining the device a user looking at.

22. The method of claim 19, wherein the step of identifying the device comprises determining the device a user is gesturing toward.

23. The method of claim 1, wherein the selected one of the plurality of values causes a change of the function selected from the group consisting of: decreasing the function, increasing the function, maximizing the function and minimizing the function.

24. A system comprising:
a database for storing positions of a first object and a second object;
at least one camera to capture the position of the first object and the second object;
a processor connected to the database, the processor configured to:
determine at a first time a first distance between the first object and the second object, wherein the first object and the second object are not in physical contact with a device, where the device comprises a function with a plurality of selectable values;
determine at a second time a second distance between the first object and the second object;
determine the difference between the first distance and the second distance; and
select one of the plurality of selectable values based on the determined difference.
